(19) United States
(12) Patent Application Publication
(10) Pub. No.: US 2014/0281990 A1
(43) Pub. Date: Sep. 18, 2014

(54) INTERFACES FOR SECURITY SYSTEM CONTROL

(71) Applicant: Oplink Communications, Inc., Fremont, CA (US)

(72) Inventors: Keqin Gu, Fremont, CA (US); Yan Qi, Fremont, CA (US); Tsungyen Chen, Palo Alto, CA (US)

(73) Assignee: Oplink Communications, Inc., Fremont, CA (US)

(21) Appl. No.: 13/837,235

(22) Filed: Mar. 15, 2013

(51) Int. Cl. G06F 3/0488

(52) U.S. Cl. CPC G06F 3/0488
USPC 715/719

(57) ABSTRACT

Methods, systems, and apparatus, including computer programs encoded on computer storage media, for controlling security systems. One of the methods includes receiving, at a mobile device, an input to present camera video content; presenting, in a user interface, a first array of video content, wherein the respective video content is associated with a first security system location; receiving a user input to present a second array of video content, wherein the respective video content is associated with a second security system location, and wherein the user input comprises a touch input; and presenting, in the user interface, the second array of video content.

### BACKGROUND

This specification relates to user interfaces.

Conventional security systems can include one or more security cameras and/or one or more sensors positioned at different points of a security system location, e.g., a home or office.

### SUMMARY

In some implementations, one or more security systems can be controlled using a mobile application. The mobile application can present, e.g., in response to a user input, in a user interface an array of video steams associated with a security system location. For example, the array can include multiple panels, each panel presenting video content associated with a corresponding camera positioned at the security system location. The security system location can be, for example, a home, office, or other location.

The mobile application can allow the user to view corresponding arrays of video streams associated with one or more other security system locations. In particular, the mobile device can be a smartphone having a touch interface. The user can use a touch input to switch between screens of the user interface in order to view different arrays of video content. For example, the user can use a swipe gesture to switch from one array of video content to presentation of another array of video content within the user interface of the mobile application. Each array can be associated with a separate security system location or can include a custom array of user selected video content across one or more security system locations.

The custom array can be generated by a user. In some implementations, a user can select video content, e.g., corresponding to a particular video stream, and drag it to a location in the user interface to add the respective video content to the custom array. For example, the user can use a touch drag and drop input to copy a video stream from a particular array to the custom array.

In general, one innovative aspect of the subject matter described in this specification can be embodied in methods that include the actions of receiving, at a mobile device, an input to present camera video content; presenting, in a user interface, a first array of video content, wherein the respective video content is associated with a first security system location; receiving a user input to present a second array of video content, wherein the respective video content is associated with a second security system location, and wherein the user input includes a touch input; and presenting, in the user interface, the second array of video content. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The touch input is a gesture includes a directional swipe. A second touch input gesture in an opposite direction returns the user interface to presenting the first array of video streams. A third touch input gesture in a same direction results in presenting a third array of video content for a third security system location. The first array of video content includes four panels presenting respective video streams, each video stream associated with a different security system camera at the first security system location. The method includes animating a transition from the first array of video content to the second array of video content responsive to the touch input.

In general, one innovative aspect of the subject matter described in this specification can be embodied in methods that include the actions of presenting, in a user interface of a mobile device, a first array of video content associated with a first security system location; receiving a touch user input selecting a first video content of the first array for addition to a custom array of video content; generating a custom array of video content and adding the first video content to the custom array of video content; receiving a touch user input selecting a second video content of a second array of video content associated with a second security system location; and adding the second video content of the second array to the custom array. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Generating the custom array of video content is performed in response to a user touch input dragging the selected first video content to a location in the user interface. The first array of video content includes a panel of four video streams, each video stream associated with a different security system camera at the first security system location. The user interface selectively displays the custom array or the first array in response to a user touch input gesture. The method includes receiving a touch user input selecting a second video content of the first array of video content; and adding the second video content of the first array of video content to the custom array. The method includes receiving a touch user input selecting a first video content of a third array of video content, wherein the third array of video content is associated with a third security system location; and adding the first video content of the third array of video content to the custom array

Particular embodiments of the subject matter described in this specification can be implemented so as to realize one or more of the following advantages. Users can be presented with an array of video for multiple cameras of a given security system location concurrently and can also easily switch between arrays for different security system locations using input gestures. Users can also generate a custom screen of video content copied from arrays for multiple security system locations using, for example, drag and drop techniques. The custom screens can be used to generate different video profiles based on user specified criteria, for example, based on common physical location, security parameters, personal needs, etc.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system for controlling multiple security systems.

FIG. 2 is a diagram of an example security system architecture.

FIG. 3 is an example mobile device displaying a security system interface configured to present video content associated with a first security system location.

FIG. 4 is an example mobile device displaying a security system interface configured to present video content associated with a second security system location.

FIG. 5 is a flow diagram of an example method for switching between security system locations.

FIG. 6 is an example mobile device displaying a security system interface configured to present a custom set of video content associated multiple security system locations.

FIG. 7 is a flow diagram of an example method for generating a custom array of video content.

Like reference numbers and designations in the various drawings indicate like elements.

### DETAILED DESCRIPTION

FIG. 1 is a diagram of an example system 100 for controlling multiple security systems. In particular, the system 100 includes security systems 102, 104, 106, and 108 coupled to a service provider system 110 and a mobile device 114 through a network 112.

Each security system 102, 104, 106, and 108 can correspond to a security system associated with a given user of the mobile device 114, e.g., an owner. Each security system 102, 104, 106, and 108 is at a particular geographic location.

For example, security system 102 can represent a security system of the user's home while security system 104 can represent a security system of the user's business. The security system 102 includes, for example sensors 118, cameras 120, and a security system manager 122. Examples of these devices are described in greater detail with respect to FIG. 2.

The service provider system 110 interacts with the security management device of each security system 102, 104, 106, and 108 and authorized devices, e.g., the mobile device 114, to perform various functions and/or services.

The mobile device 114 can be a mobile phone, tablet, laptop, or other mobile device. The mobile device 114 can include an application or other software that allows the user of the mobile device 114 to view and control one or more associated security systems. In particular, the application can provide a user interface 116 that allows the user of the mobile device 114 to view information about, and control, one or more of the security systems 102, 104, 106, and 108. In the example user interface 116 shown in FIG. 1, video content is presented in a four part array, each portion corresponding to a different camera of a particular security system, e.g., cameras 120 of security system 102.

FIG. 2 is a diagram of an example security system architecture 200. For example, the security system architecture 200 can represent components associated with a single one of the security systems shown in FIG. 1, e.g., security system 102.

The security system 200 includes a secure wireless network 202, which is connected through the Internet 204 to a service provider system 206.

The secure wireless network 202 includes a security management device 208 and wireless enabled devices 210, 212. The security management device 208 can be an access point device. The wireless enable devices 210, 212 can be preprogrammed with respective keys. In some implementations, the security management device 208, optionally in conjunction with the service provider system 206, can determine and use the appropriate keys to configure the wireless enabled devices 210, 212 thereby establishing a self-configured secure wireless network 202 with minimal or no user interaction.

In a typical home security system, several strategically positioned cameras 210 and sensors 212 may be included. In addition to sensors included for security purposes such as movement and displacement sensors, for example, detecting the opening of doors and windows, other sensors providing other useful information may be included such as doorbell sensors, smoke detector alarm sensors, temperature sensors, and/or environmental control sensors and/or controls.

In this example, the security management device 208 includes a router for the home security system. Therefore, all devices that are to be networked are communicatively coupled to the security management device 208. To this end, the security management device includes at least one of an Ethernet receptacle or Universal Serial Bus (USB) receptacle so that various devices such as a computer 214 may be wire-coupled to it, e.g., through an Ethernet connection. The security management device 208 is configured to be in “router” mode. As such it can be referred to as being a router security management device.

The security management device 208 is communicatively coupled, e.g., through an Ethernet connection, to a network adapter 216, e.g., a modem or directly to the Internet through an ISP. In some implementations, a broadband connection is used for high speed transmission of video data from the one or more wireless cameras and sensor data from the wireless sensors. The security management device 208 can include a Dynamic Host Configuration Protocol (DHCP) server which is configured to assign IP subaddresses to devices connecting through the security management device 208 to the Internet 204.

In some implementations, the security management device 208 includes a software agent residing in it that establishes communication with a remote service provider system 206 upon the security management device 208 being powered up and after it has been joined to the Internet 204 through the network adapter 216, which serves as an Internet gateway. The service provider system 206 interacts with the security management device 208 and authorized devices, e.g., mobile device 218, to perform various functions and/or services.

The mobile device 218 can include a software agent or resident application for interaction with the service provider system 206. Devices that are attempting to interact with the service provider system 206 may confirm their authority to the service provider system 106, for example, by providing information that uniquely identifies the requesting device, e.g., an Internet Protocol (IP) address, a product serial number, or a cell phone number. Alternatively, they may provide a user name and password which are authorized to interact with the secure wireless network 202. To facilitate such authorization procedures, the service provider system 204 can store or have ready access to such authorization information for each secure wireless network of users who subscribe to the service. The mobile device 218 can be used to receive information from the security system, e.g., alarm information, as well as used to control functions of the security system.

FIG. 3 is an example mobile device 302 displaying a security system interface 304 configured to present video content associated with a first security system location. The security system interface 304 is provided, for example, by a mobile application installed on the mobile device 302. The security system interface 304 is shown as a touch interface. However, other mobile device interfaces can be used.

In particular, the security system interface 304 includes a menu area 306 and a video display area 308. The menu area 306 can include menu items for receiving information about one or more security system as well as security system control. For example, the “videos” menu item 310 allows the user of the mobile device 302 to view video content from one or more security system cameras. The “arm” menu item 312 allows the user to remotely activate or deactivate one or more security systems. Other menu items can be included, for example, to access application settings or to return to a home screen of the interface.

Additionally, in response to an alarm, the application can present a notification overlay displayed over the present interface of the mobile device. The user can then activate the security system interface 304 to learn more about the alarm.

In the example interface shown, the “videos” menu item 310 is selected, resulting in video content displayed in the video display area 308. When other menu items are selected, the region of the video display area 308 can present other security system content.

The video display area 308 includes an array including a number of distinct panels. Each panel presents video from a distinct camera source, if available. For example, the upper left panel 314 displays video content from a camera positioned in a living room of a home security system. In the example shown in FIG. 3, each panel displays video content from a distinct video camera associated with a particular video camera of the security system location, e.g., the user's home. Thus, a single interface display can present views of multiple camera feeds concurrently. The video content can be live video, video clips of a specified duration, or still images. If still images are presented, they can be periodically refreshed with a newer still image. Not all panels of the array need contain video content.

There may be more than one security system location. For example, the user may have, in addition to the home location shown, security systems at a business or second home locations.

FIG. 4 is an example mobile device 302 displaying a security system interface 304 configured to present video content associated with a second security system location. As with the first security system location, the video display area 308 includes an array including a number of distinct panels. In particular, each panel of the video display area 308 presents video content from a distinct camera source associated with the second security system location. For example, the upper left panel 402 displays video content from a camera positioned at the door of a business location as part of a business security system.

Each security system location can be associated with a different screen of the user interface video display area 308. An indicator 316 shows the presently displayed screen of the video display area 308 (filled circle) relative to one or more other screens (empty circles). The user can change screens of the user interface, for example, using one or more touch gestures including swiping in a horizontal direction relative to the user interface orientation. Thus, for example, a horizontal swipe in a first direction can cause the displayed screen of the video display area 308 to change from the video content associated with the first security system location show in FIG. 3 to the video content associated with the second security system location shown in FIG. 4. Navigating between video content of different security system locations is described below with respect to FIG. 5.

FIG. 5 is a flow diagram of an example method 500 for switching between locations. For convenience, the method 500 will be described with respect to a system, e.g., a mobile device such as mobile device 302 executing a security system application, that performs the method 500.

The system receives an input to present camera video content (505). For example, video content can be presented by default when the user opens the security system application. In another example, the user can select a video menu item within the application to display camera video content. The received input can be a touch input or an input provided by another input device, e.g., a stylus, keyboard, or track ball.

The system presents video content for a first security system location (510). In some implementations, the user has only one associated security system. However, in other implementations, the user is associated with more than one security system having a corresponding security system location. For example, the user may have a home security system, a business security system, and a vacation home security system.

When the user is associated with more than one security system location, the system presents video content for a first security system location, video data for a video screen having a default position with respect to multiple screens, or based on some other criteria. The video content for the first security system location can be presented as multiple video streams in a single interface screen. For example, video content from four distinct cameras at the security system location can be presented concurrently, for example, using a split screen separating the display area into four quadrants e.g., as shown in in FIG. 3.

The system receives a user input gesture to change security system location (515). The user input gesture can be, for example, a touch input gesture. For example, the user can provide a substantially horizontal swiping touch input across the user interface. Other types of input can be received, for example, particular key inputs or trackball inputs.

In response to the received user input gesture, the system presents video content for a second security system location (512). The video content can be presented as described above with respect to step (510). The video content for the second security system location can be presented as multiple video streams in a single interface screen. For example, video content from four distinct cameras at the second security system location can be presented concurrently. In some implementations, the user interface can animate the transition from the screen showing video content from the first security system location to the screen showing video data from the second security system location.

If an additional user input is received, e.g., an additional touch gesture, in the same direction, the system can present video content for a third security system location. If no additional security system location is present, the touch gesture can result in no changes to the user interface. If the additional user input is associated with another direction, e.g., a substantially horizontal touch gesture in the opposite direction, the system can return to a screen presenting video content for the first security system location.

FIG. 6 is an example mobile device 602 displaying a security system interface 604 configured to present a custom set of video content associated with multiple locations. The security system interface 604 is provided, for example, by a mobile application installed on the mobile device 602. The security system interface 604 is shown as a touch interface. However, other mobile device interfaces can be used.

In particular, the security system interface 604 includes a menu area 606 and a video display area 608. The menu area 606 can include menu items for receiving information about one or more security system as well as security system control similar to the menu area 603 shown in FIGS. 3 and 4.

In the example interface shown, the “videos” menu item 610 is selected, resulting in video content displayed in the video display area 608. When other menu items are selected, the region of the video display area 608 can present other security system content.

The video display area 608 includes an array including number of distinct panels. Each panel presents video from a distinct camera source, if available. For example, the upper left panel 614 displays video content from a camera positioned in a living room of a home security system. In the example shown in FIG. 6, each panel displays video content from a distinct video camera associated with a particular security system location. Thus, while the upper left panel 614 is associated with a video camera from a first security system location, e.g., the user's home, the upper right panel is associated with a video camera from a second security system location, e.g., the user's business. Thus, a single interface display can present views of multiple camera feeds associated with multiple security system locations concurrently. The video content can be live video, video clips of a specified duration, or still images. If still images are presented, they can be periodically refreshed with a newer still image.

The particular array of video content can be customized by the user. The user can generate a custom screen for presentation in the video display area 608 that combines user selected video content taken from arrays of video content associated with different security system locations. Generating the custom array of video content is described below with respect to FIG. 7.

FIG. 7 is a flow diagram of an example method 700 for generating a custom array of video content. For convenience, the method 700 will be described with respect to a system, e.g., a mobile device such as mobile device 302 executing a security system application, that performs the method 700

The system presents a first array of video content associated with a first security system location (705). For example, a user interface of an application can present a video region including an array of individual video content associated with the first security system location. The array can be a four panel array, for example, as shown in FIG. 3. The video content can be streaming video feeds, video clips, or still images from the corresponding video cameras.

The system receives an input selecting a first video content to add to a custom array of video content (710). In particular, in an array of video content, the user can select a particular panel corresponding to content from one particular video camera at the first security system location. In some implementations, the first array of video content is present on a mobile device having a touch screen interface. The user can select a particular video using a touch input, for example, placing and holding a finger on the corresponding video for a specified length of time.

In response, application logic generates a representation of the video content that moves with the user's finger such that the user can drag the video content to a new location. If the user drags the representation of the video to an edge, e.g., a left or right edge, of the interface, the interface will switch to a new screen. In other implementations, the user can use other drag and drop techniques to select and move a representation of the first video content, e.g., using a pointer or other cursor, key strokes, etc. In some implementations, dragging the video content to a new location places a copy of the video at that location, e.g., the original video content is maintained at its original location. In some other implementations, the video content is moved to the new location.

The system generates the custom array of video content including the first video content (715). When the use drags the representation of the first video content to an edge where there are no additional screens, a new custom screen including a blank custom array is generated. When the user releases the representation of the first video content, e.g., by lifting their finger in a touch interface, the video is dropped to the first panel of the custom array. The user can navigate to and from the custom screen in the same manner as between other screens, e.g., using a horizontal swiping motion as described above.

The system presents a second array of video content associated with a second security system location (720). For example, the user can navigate to another screen that displays video content for the second security system location, for example, a business location as show in FIG. 4. The second array of video content is presented in a similar manner as described above.

The system receives an input selecting a second video content to add to the custom array of video content (725). In particular, in an array of video content, the user can select a particular panel corresponding to content from a particular video camera at the second security system location. The selection can be performed in a similar manner as described above with respect to selecting the first video content.

The system adds the selected second video content to the custom array of video content (730). The user can drag a representation of the selected second video content to the custom array of video content. When the user releases the representation of the second video content, e.g., by lifting their finger in a touch interface, the video is dropped to the next empty panel of the custom array, e.g., the second panel. Consequently the user can generate a custom array that includes video content from one or more different security system locations that are otherwise presented on separate screens of the security system interface.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, at a mobile device, an input to present camera video content;
presenting, in a user interface, a first array of video content, wherein the respective video content is associated with a first security system location;
receiving a user input to present a second array of video content, wherein the respective video content is associated with a second security system location, and wherein the user input comprises a touch input; and
presenting, in the user interface, the second array of video content.

2. The method of claim 1, wherein the touch input is a gesture comprising a directional swipe.

3. The method of claim 2, wherein a second touch input gesture in an opposite direction returns the user interface to presenting the first array of video streams.

4. The method of claim 2, wherein a third touch input gesture in a same direction results in presenting a third array of video content for a third security system location.

5. The method of claim 1, wherein the first array of video content comprises four panels presenting respective video streams, each video stream associated with a different security system camera at the first security system location.

6. The method of claim 1, comprising animating a transition from the first array of video content to the second array of video content responsive to the touch input.

7. A method comprising:
presenting, in a user interface of a mobile device, a first array of video content associated with a first security system location;
receiving a touch user input selecting a first video content of the first array for addition to a custom array of video content;
generating a custom array of video content and adding the first video content to the custom array of video content;
receiving a touch user input selecting a second video content of a second array of video content associated with a second security system location; and
adding the second video content of the second array to the custom array.

8. The method of claim 7, wherein generating the custom array of video content is performed in response to a user touch input dragging the selected first video content to a location in the user interface.

9. The method of claim 7, wherein the first array of video content comprises a panel of four video streams, each video stream associated with a different security system camera at the first security system location.

10. The method of claim 7, wherein the user interface selectively displays the custom array or the first array in response to a user touch input gesture.

11. The method of claim 7, comprising:
receiving a touch user input selecting a second video content of the first array of video content; and
adding the second video content of the first array of video content to the custom array.

12. The method of claim 7, comprising:
receiving a touch user input selecting a first video content of a third array of video content, wherein the third array of video content is associated with a third security system location; and
adding the first video content of the third array of video content to the custom array.

13. A computer storage medium encoded with a computer program, the program comprising instructions that when executed by one or more computers cause the one or more computers to perform operations comprising:
receiving, at a mobile device, an input to present camera video content;
presenting, in a user interface, a first array of video content, wherein the respective video content is associated with a first security system location;
receiving a user input to present a second array of video content, wherein the respective video content is associated with a second security system location, and wherein the user input comprises a touch input; and
presenting, in the user interface, the second array of video content.

14. A computer storage medium encoded with a computer program, the program comprising instructions that when executed by one or more computers cause the one or more computers to perform operations comprising:
presenting, in a user interface of a mobile device, a first array of video content associated with a first security system location;
receiving a touch user input selecting a first video content of the first array for addition to a custom array of video content;
generating a custom array of video content and adding the first video content to the custom array of video content;
receiving a touch user input selecting a second video content of a second array of video content associated with a second security system location; and
adding the second video content of the second array to the custom array.

15. A system comprising:
one or more computers configured to perform operations comprising:
receiving, at a mobile device, an input to present camera video content;
presenting, in a user interface, a first array of video content, wherein the respective video content is associated with a first security system location;
receiving a user input to present a second array of video content, wherein the respective video content is associated with a second security system location, and wherein the user input comprises a touch input; and
presenting, in the user interface, the second array of video content.

16. A system comprising:
one or more computers configured to perform operations comprising:
presenting, in a user interface of a mobile device, a first array of video content associated with a first security system location;
receiving a touch user input selecting a first video content of the first array for addition to a custom array of video content;
generating a custom array of video content and adding the first video content to the custom array of video content;
receiving a touch user input selecting a second video content of a second array of video content associated with a second security system location; and
adding the second video content of the second array to the custom array.
